(19) United States
(12) Patent Application Publication
(10) Pub. No.: US 2014/0258793 A1
(43) Pub. Date: Sep. 11, 2014

(54) DETECTING SYSTEM AND METHOD FOR MOTHERBOARD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: LI-WEN GUO, Shenzhen (CN)

(73) Assignees: HON HAI PRECISION INDUSTRY CO., LTD., New Taipai (TW); HONG FU JIN PRECISION INDUSTRY (ShenZhen) CO., LTD., Shenzhen (CN)

(21) Appl. No.: 14/062,898

(22) Filed: Oct. 25, 2013

(30) Foreign Application Priority Data
Mar. 7, 2013 (CN) 2013100721034

(51) Int. Cl. G06F 11/07

(52) U.S. Cl. CPC G06F 11/0766
USPC 714/57

(57) ABSTRACT

A system for detecting a motherboard includes a host computer connected to the motherboard. The motherboard includes a plurality of devices connected to each other via I2C bus. The system further includes a PLD connected to the plurality of devices via the I2C bus. The host computer sends instructions to the PLD and instructs the PLD to read information of the plurality of devices. The PLD sends the information read from the plurality of devices to the host computer. The host computer analyses the information and display a test result. The present disclosure further discloses a method for detecting the motherboard.

### BACKGROUND

1. Technical Field

The present disclosure relates to a motherboard detecting system and method of detecting a motherboard.

2. Description of Related Art

A motherboard of a server has complicated circuitry. To repair or detect the motherboard, operators utilize test tools, such as an oscilloscope and an analyzing apparatus, to detect signals generated by the motherboard, which is inconvenient.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a motherboard detecting system.

FIG. 2 is a detailed block diagram of a Programmable Logic Device (PLD) of FIG. 1.

FIG. 3 is a flow chart of an embodiment of a motherboard detecting method according to an embodiment.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean “at least one.”

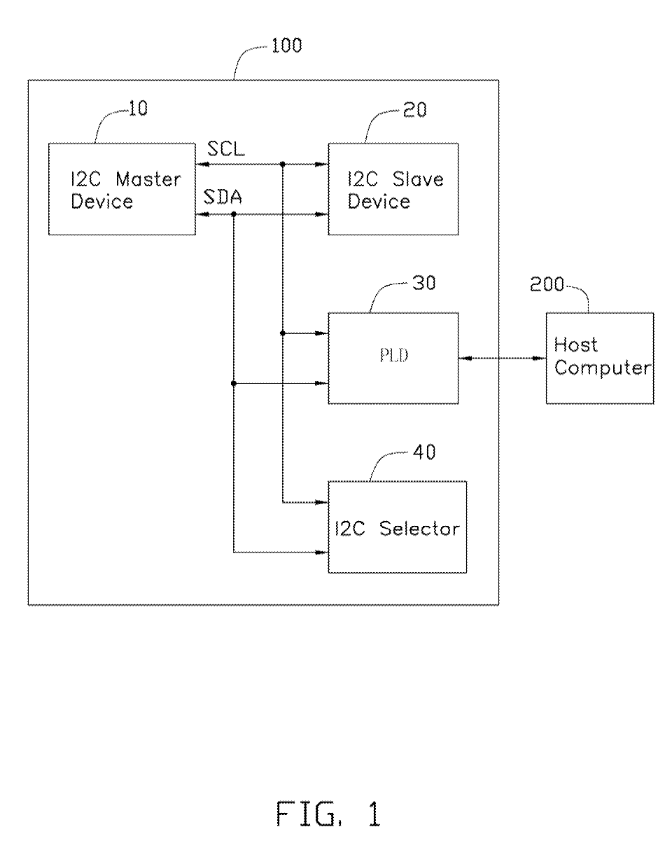

FIG. 1 shows an embodiment of a detecting system including a motherboard 100 and a host computer 200 connected to the motherboard 100.

The motherboard 100 includes a plurality of devices connected to each other via an I2C bus. The plurality of devices includes an I2C master device 10, an I2C slave device 20, a PLD 30, and an I2C selector 40. The I2C master device 10, the I2C slave device 20, the PLD 30, and the I2C selector 40 are connected to each other via an I2C bus. The I2C bus includes a clock (SCL) line and a data (SDA) line. The host computer 200 is connected to the PLD 30. In one embodiment, the I2C master device 10 is a CPU. The PLD 30 is a Complex Programmable Logic Device (CPLD) or a Field-Programmable Gate Array (FPGA). The PLD 30 and the I2C selector 40 are mounted on the motherboard 100 for facilitating detection of the motherboard 100.

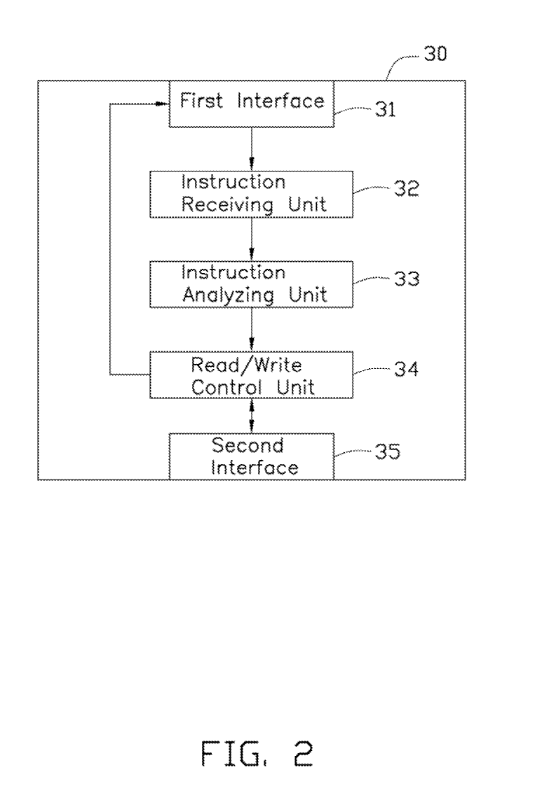

FIG. 2 shows the PLD 30 includes a first interface 31 configured to connect the host computer 200, an instruction receiving unit 32, an instruction analyzing unit 33, a read/write control unit 34 connected to the instruction analyzing unit 33, and a second interface 35 configured to connect the I2C bus. The read/write control unit 34 is connected to both the first interface 31 and the second interface 35. In one embodiment, the first interface 31 is a USB interface connected to the host computer 200, and the second interface 35 is an I2C interface connected to the I2C bus. The instruction receiving unit 32 receives an instruction sent from the host computer 200 via the first interface 31. The instruction analyzing unit 33 analyzes the instruction. If the instruction is a read instruction, the read/write control unit 34 reads information from the motherboard 100. If the instruction is a write instruction, the read/write control unit 34 writes information to the motherboard 100.

To detect the motherboard 100, the host computer 200 sends instructions to the PLD 30. The instructions may include a read instruction for reading information from the I2C master device 10 and the I2C slave device 20. The instructions may include a write instruction for writing information to the motherboard 100 for adding or updating data in the I2C master device 10 and the I2C slave device 20. If the PLD 30 receives the write instruction, the PLD 30 informs the I2C selector 40. The I2C selector 40 enables the PLD 30 to be an I2C main control device. The PLD 30 writes information to the I2C master device 10 and/or the I2C slave device 20 according to the write instruction. If the PLD 30 does not receive any write instruction, the I2C master device 10 is enabled to be the I2C main control device. The I2C master device 10 can control the I2C slave device 20 and other I2C slave device 20 of the motherboard 100. If the PLD 30 receives the read instruction from the host computer 200, the PLD 30 reads information from the I2C master device 10 and the I2C slave device 20. The information read by the PLD 30 is sent to the host computer 200. The host computer 200 analyzes the information read from the motherboard 100 and displays a detection result of the motherboard 100.

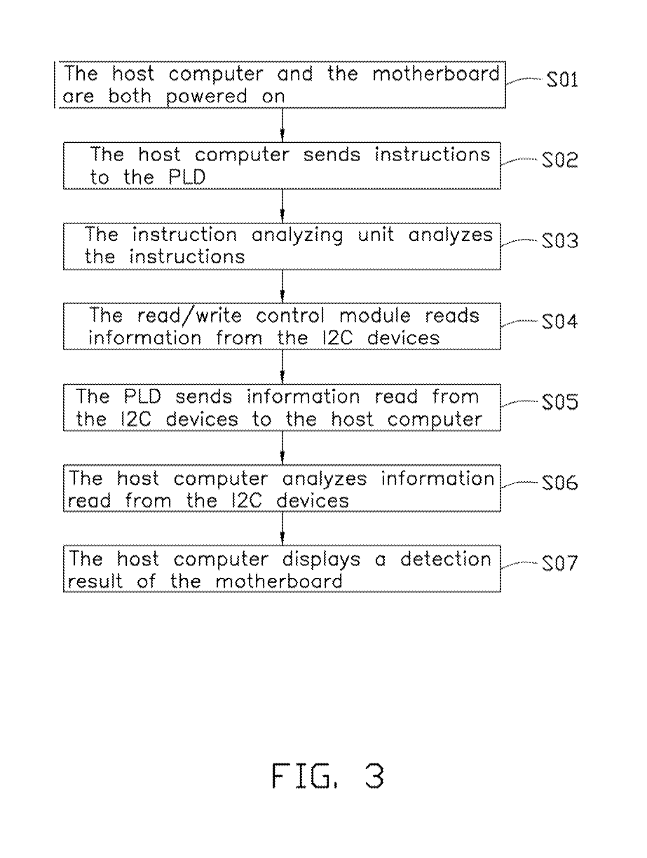

FIG. 3 shows a flow chart of an embodiment of a detecting method based upon the above detecting system. The detecting method includes the following blocks.

In block S01, the host computer 200 and the motherboard 100 are both powered on.

In block S02, the host computer 200 sends instructions to the PLD 30. The instruction receiving unit 32 receives the instructions via the first interface 31. The instructions may include a read instruction or a write instruction.

In block S03, the instruction analyzing unit 33 analyzes the instructions.

In block S04, the read/write control unit 34 reads information from the I2C devices (including the I2C master device 10 and the I2C slave device 20) according to the read instruction. In one embodiment, the read/write control unit 34 can also write information to the I2C devices according to the write instruction.

In block S05, the PLD sends information read from the I2C devices to the host computer via the first interface 31.

In block S06, the host computer 200 analyzes information read from the I2C devices.

In block S07, the host computer 200 displays a detection result of the motherboard 100. The detection result is indicative of addresses, names and data of the I2C devices. The detection result also indicates whether there is any error in the detected data.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, any indication used is only to be viewed for identification purposes and not as a suggestion as to an order for the steps.

What is claimed is:

1. A detecting system comprising a motherboard and a host computer connected to the motherboard, wherein the motherboard comprises a plurality of devices connected to each other via an I2C bus and a PLD connected to the plurality of devices via the I2C bus, the host computer is capable of sending instructions to the PLD and instructing the PLD to read information of the plurality of devices, the PLD is capable of sending the information read from the plurality of devices to the host computer, and the host computer is capable of analyzing the information and displaying a detection result of the motherboard.

2. The detecting system of claim 1, wherein the motherboard further comprises an I2C selector connected to the I2C bus, and the I2C selector is capable of selecting one of the plurality devices or the PLD to control other devices connected to the I2C bus.

3. The detecting system of claim 2, wherein the instructions comprises a read instruction for reading information from the plurality of devices and a write instruction for writing information to the motherboard for adding or updating data in the plurality of devices.

4. The detecting system of claim 3, wherein when the PLD receives the write instruction, the PLD is enabled to be the main control device by the I2C selector.

5. The detecting system of claim 1, wherein the PLD comprises a first interface connected to the host computer and a second interface connected to the I2C bus.

6. The detecting system of claim 5, wherein the first interface is a USB interface, and the second interface is an I2C interface.

7. The detecting system of claim 5, wherein the PLD further comprises an instruction receiving unit connected to the first interface for receiving the instructions, an instruction analyzing unit connected to the instruction receiving unit for analyzing the instructions, and a read/write control unit connected to the instruction analyzing unit; and the read/write control unit is connected to the first interface and the second interface for reading information from the plurality of devices or writing information to the plurality of devices.

8. The detecting system of claim 1, wherein the PLD is a CPLD or a FPGA.

9. A method for detecting a motherboard comprising:
connecting a PLD to a plurality of devices of the motherboard via an I2C bus;
sending instructions to a PLD mounted on the motherboard from a host computer;
wherein the instructions comprises at least one read instruction;
reading information from the plurality of devices by the PLD;
sending the information read by the PLD to the host computer; and
analyzing the information and displays a detection result of the motherboard.

10. The method of claim 9, wherein the instructions further comprises a write instruction, and the PLD writes information to the plurality of devices when receiving the write instruction.

11. The method of claim 10, wherein the plurality of devices comprises an I2C master device and at least one I2C slave device; when the PLD receives the write instruction, the PLD is selected to be a main control device to control the I2C master device and the at least one I2C slave device; when the PLD does not receive any write instruction, the I2C master device is selected to be the main control device to control the I2C slave device.
